(19) United States
(12) Patent Application Publication
(10) Pub. No.: US 2017/0177174 A1
(43) Pub. Date: Jun. 22, 2017

(54) DISPLAY APPARATUS AND DISPLAY METHOD

(71) Applicant: SAMSUNG ELECTRONICS CO., LTD., Suwon-si (KR)

(72) Inventors: Hee-jin KO, Bucheon-si (KR); Ji-eun BYUN, Seoul (KR)

(73) Assignee: SAMSUNG ELECTRONICS CO., LTD., Suwon-si (KR)

(21) Appl. No.: 15/338,551

(22) Filed: Oct. 31, 2016

(30) Foreign Application Priority Data
Dec. 17, 2015 (KR) 10-2015-0181084

(51) Int. Cl. G06F 3/0482; G06F 3/0484

(52) U.S. Cl. CPC G06F 3/0482; G06F 3/04845

(57) ABSTRACT

A display apparatus includes a display, and a processor configured to control the display to provide a first item area that displays at least a portion of a first item list including a plurality of items, provide a second item area that displays, in response to a control signal of a controller, for moving a focus to a first item included in the first item area, at least a portion of a second item list including lower-level items of corresponding to the focused first item, and modify, in response to a control signal for moving the focus to a second item included in the second item area, the item list included in the first item area.

### CROSS-REFERENCE TO RELATED APPLICATION

This application claims priority from Korean Patent Application No. 10-2015-0181084, filed on Dec. 17, 2015, in the Korean Intellectual Property Office, the disclosure of which is incorporated herein by reference in its entirety.

### BACKGROUND

1. Field

Apparatuses and methods according to exemplary embodiments relate to display apparatuses and display methods, and more particularly, to display apparatuses providing a plurality of item areas and display methods thereof.

2. Description of the Related Art

Display apparatuses are used for displaying images that may be viewed by users. Users may watch broadcast content displayed on display apparatuses. Display apparatuses display, on screens, broadcast content that users may choose from among broadcasting signals sent from broadcasting stations. Currently, there is a worldwide trend for broadcasting to be converted from analog broadcasting to digital broadcasting.

Digital broadcasting refers to transmitting digital images and audio signals. Compared to analog broadcasting, digital broadcasting is robust with respect to external noise, and thus, has less data loss, has better error correction, has high resolution, and provides vivid screens. In addition, unlike analog broadcasting, digital broadcasting may provide a bi-directional service.

Also, smart televisions (TVs) providing various pieces of content in addition to digital broadcasting functions have recently been provided. Accordingly, smart TVs provide categorized content so that users may easily find desired content from among the various pieces of content.

### SUMMARY

Provided are display apparatuses and methods, in which an item list is modified and displayed so that various items may be checked without moving a screen.

Additional aspects will be set forth in part in the description which follows and, in part, will be apparent from the description, or may be learned by practice of the exemplary embodiments.

According to an aspect of an exemplary embodiment, there is provided a display apparatus including a memory; and a processor configured to control the display to: provide a first item area that displays at least a portion of a first item list including a plurality of items; provide a second item area that, in response to receiving a control signal of a controller for moving a focus to a first item in the first item area, displays at least a portion of a second item list including lower-level items corresponding to the focused first item, and modify, in response to receiving a control signal for moving the focus to a second item in the second item area, the first item list.

The modifying the first item list may include downscaling the first item list.

The processor may be further configured to control the display to arrange the first item area vertically and arrange the second item area horizontally.

The processor may be further configured to control the display to arrange the first item area horizontally and arrange the second item area vertically.

The processor may be further configured to, in response to receiving the control signal for moving the focus to the first item, control the display to display the first item by moving the first item to a predetermined location as the first item list slides, and arrange the second item area to be adjacent to the predetermined location to which the first item is moved.

The predetermined location may be a first location of the first item area, and the processor may be further configured to control the display to arrange the second item area to be adjacent to the first location and orthogonal to the first item area.

The processor may be further configured to, in response to receiving the control signal for moving the focus to the first item, control the display to move the focus to a location of the first item, and arrange the second item area to be adjacent to the location of the first item and orthogonal to the first item area.

The processor may be further configured to control the display to arrange the first item area horizontally and arrange the second item area horizontally above the first item area.

The processor may be further configured to, in response to receiving a control signal for moving the focus to the second item in the second item area, control the display to display at least a portion of the second item list including lower-level items of the second item.

According to an aspect of another exemplary embodiment, there is provided a method for displaying a plurality of items, the method including: providing a first item area that displays at least a portion of a first item list including a plurality of items; providing a second item area that, in response to a receiving control signal of a controller, for moving a focus to a first item in the first item area, displays at least a portion of a second item list including lower-level items corresponding to the focused first item; and modifying, in response to receiving a control signal for moving the focus to a second item in the second item area, the first item list in the first item area.

The modifying of the first item list may include downscaling the first item list.

The first item area may be arranged vertically, and the second item area may be arranged horizontally.

The first item area may be arranged horizontally, and the second item area may be arranged vertically.

The method may include, in response to receiving the control signal for moving the focus to the first item, displaying the first item by moving the first item to a predetermined location as the first item list slides, and arranging the second item area to be adjacent to the predetermined location to which the first item is moved.

The predetermined location may be a first location of the first item area, and the second item area may be arranged adjacent to the first location and orthogonal to the first item area.

The focus may be moved to a location of the first item in response to receiving the control signal for moving the focus to the first item, and the second item area may be arranged adjacent to the location of the first item and orthogonal to the first item area.

The first item area may be arranged horizontally, and the second item area may be arranged horizontally above the first item area.

The method may further include providing a third item area that, in response to receiving a control signal for moving the focus to the second item in the second item area, displays at least a portion of the second item list including lower-level items of the second item.

The first item list displayed on the first item area may indicate at least one category, and the second item list displayed on the second item area may indicate at least one piece of content that corresponds to each category.

A non-transitory computer-readable recording medium may have recorded thereon a program for causing a computer to perform the method.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 illustrates an example of displaying a first item area and a second item area which have a 2-level structure, according to an exemplary embodiment;

FIG. 2A illustrates an example of displaying a first item area and a second item area which have a 2-level structure, according to another exemplary embodiment;

FIG. 2B illustrates an example of displaying a first item area including downscaled items, according to an exemplary embodiment;

FIG. 2C illustrates an example of displaying a first item area using icons to represent items, according to an exemplary embodiment;

FIG. 2D illustrates an example of displaying a first item area including overlapped items, according to an exemplary embodiment;

FIG. 3 illustrates an example of displaying a first item area including horizontally arranged items and a second item area including vertically arranged items, according to an exemplary embodiment;

FIG. 4 illustrates an example of displaying a first item area including horizontally arranged items and a second item area horizontally arranged on top of the first item area, according to another exemplary embodiment;

FIG. 5 illustrates an example of displaying a first item area and a second item area which have a 2-level structure, according to another exemplary embodiment;

FIGS. 6A and 6B illustrate an example of displaying first to third item areas which have a 3-level structure, according to an exemplary embodiment;

FIG. 7 is a block diagram illustrating a configuration of a display apparatus, according to an exemplary embodiment;

FIG. 8 is a block diagram illustrating a configuration of a display apparatus, according to another exemplary embodiment; and

FIG. 9 is a flowchart of a method of displaying a plurality of item areas, according to an exemplary embodiment.

### DETAILED DESCRIPTION

Exemplary embodiments will now be described in detail with reference to the accompanying drawings for those of ordinary skill in the art to be able to perform the exemplary embodiments. Exemplary embodiments may include many different forms and should not be construed as being limited to any exemplary embodiment set forth herein. Also, in the drawings, parts unrelated to the detailed description may be omitted to ensure clarity, and like reference numerals denote like elements throughout. As used herein, the term “and/or” includes any and all combinations of one or more of the associated listed items. Expressions such as “at least one of,” when preceding a list of elements, modify the entire list of elements and do not modify the individual elements of the list.

The terms used herein are selected from among general terms that are currently used, by taking into account their function. However, the terms may be different according to an intention of one of ordinary skill in the art, a precedent, or the advent of new technology. Therefore, the terms used herein are not merely designations of the terms and have to be defined based on the meaning of the terms and content throughout the present disclosure.

Also, it will be understood that, although the terms “first”, “second”, etc. may be used herein to describe various elements, these elements should not be limited by these terms. These terms are only used to distinguish one element from another.

Also, the terminology used herein is for the purpose of describing exemplary embodiments and is not intended to limit the present disclosure. As used herein, the singular forms “a”, “an”, and “the” are intended to include the plural forms as well, unless the context clearly indicates otherwise. Throughout the specification, it will be understood that, when a part is referred to as being “connected” to another part, it may be “directly connected” to the other element or “electrically connected” to the other element with an intervening device therebetween. It will be further understood that, when a part “includes” or “comprises” an element, unless otherwise defined, the part may further include other elements, not excluding other elements.

Also, connecting lines or connectors shown in the drawings are intended to represent exemplary functional relationships and/or physical or logical couplings between elements. In a practical apparatus, many alternative or additional functional relationships, physical connections or logical connections may be present.

Reference will now be made in detail to exemplary embodiments with reference to the accompanying drawings.

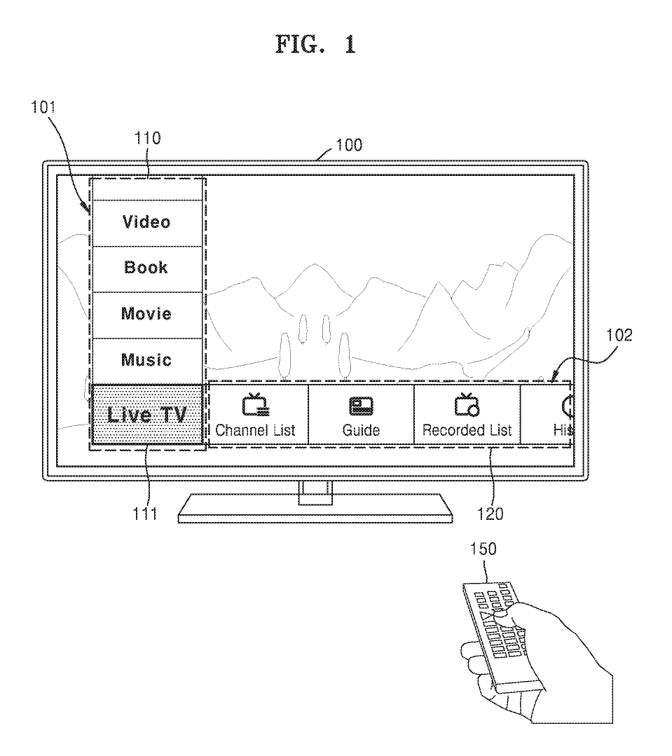

FIG. 1 illustrates an example of displaying a first item area and a second item area which have a 2-level structure, according to an exemplary embodiment.

Referring to FIG. 1, a controller 150 capable of wired or wireless communication with a display apparatus 100 is shown.

The display apparatus 100 may be a television (TV). However, this is just an exemplary embodiment, and the display apparatus 100 may be an electronic apparatus that includes a display. For example, the display apparatus 100 may be various electronic apparatuses such as a cell phone, a table personal computer (PC), a digital camera, a camcorder, a laptop computer, a desktop computer, an electronic book terminal, a digital broadcasting terminal, a personal digital assistant (PDA), a portable multimedia player (PMP), a navigation system, an MP3 player, or a wearable device. Also, the display apparatus 100 may be a fixed type or mobile type and may be a digital broadcasting receiver capable of receiving digital broadcasting.

The controller 150 may be various types of apparatuses for controlling the display apparatus 100, such as a remote control or cell phone.

Also, the controller 150 may control the display apparatus 100 by using short-range wireless communication including infrared transmission or Bluetooth. The controller 150 may control a function of the display apparatus 100 by using at least one of a provided key (including a button), a touchpad, a microphone capable of receiving a user's voice, and a sensor capable of recognizing a motion of the controller 150.

The controller 150 may include a power on/off button for turning on or off the display apparatus 100. Also, the controller 150 may perform channel change, volume adjustment, terrestrial broadcasting/cable broadcasting/satellite broadcasting selection, or configuration of the display apparatus 100 according to a user input.

Also, the controller 150 may be a pointing apparatus. For example, the controller 150 may operate as a pointing apparatus when the controller 150 receives a certain key input.

The display apparatus 100 may provide a plurality of item areas displaying item lists on a screen.

Referring to FIG. 1, the display apparatus 100 may display a first item area 101 and a second item area 102. For example, the first item area 101 may be an area in which the display apparatus 100 displays a category list 110. In this regard, a category refers to a list of classified pieces of content that may be provided by the display apparatus 100. Also, the second item area 102 may be an area that displays a content list 120 classified into a certain category.

It is assumed hereinafter in the drawings that the first item area 101 displays the category list 110, and the second item area 102 displays the content list 120 classified into a certain category. However, if the second item area 102 is an area that displays items which are at a lower level of the first item area 101, a type of items is not limited thereto. In this regard, the lower level may be construed as including detailed items corresponding to each item of the first item area 101.

The display apparatus 100 may display, based on a control signal that is input by a user via the controller 150, the content list 120 that corresponds to a category at which a current focus is located in the first item area 101 on the second item area 102. Accordingly, the content list 120 that is displayed on the second item area 102 may differ according to a location of the current focus. In this regard, the location of the current focus may be marked by color change, bold font, or the like. However, a method of marking the location of the current focus is not limited thereto.

For example, referring to FIG. 1, when the current focus is located at a Live TV item 111 in the first item area 101, the display apparatus 100 may display the Live TV item 111 by changing a color of the Live TV item 111 and may display the content list 120 that corresponds to the Live TV item 111 on the second item area 102. For example, content that corresponds to the Live TV item 111 may include a channel list, a guide, and a recorded content list.

According to an exemplary embodiment, the display apparatus 100 may modify an item list that is displayed on an item area in consideration of limited space of the screen and thus may provide various categories and pieces of content on one screen without moving the screen.

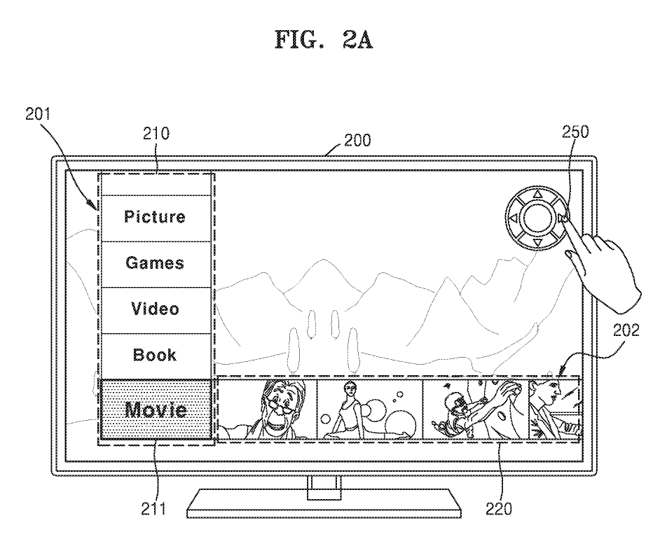

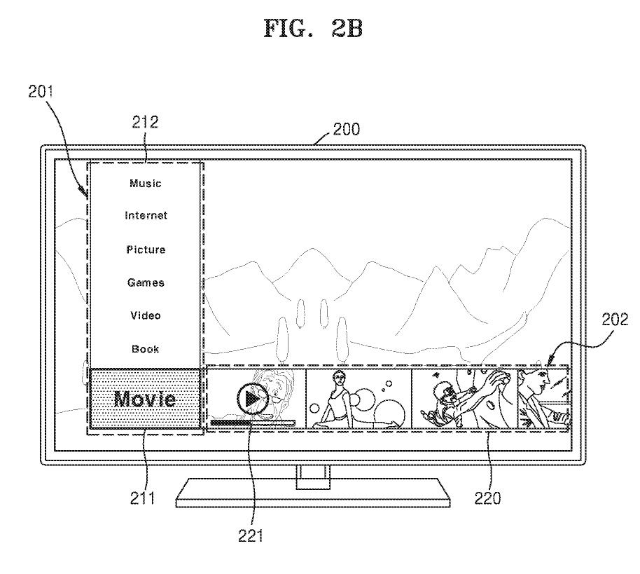

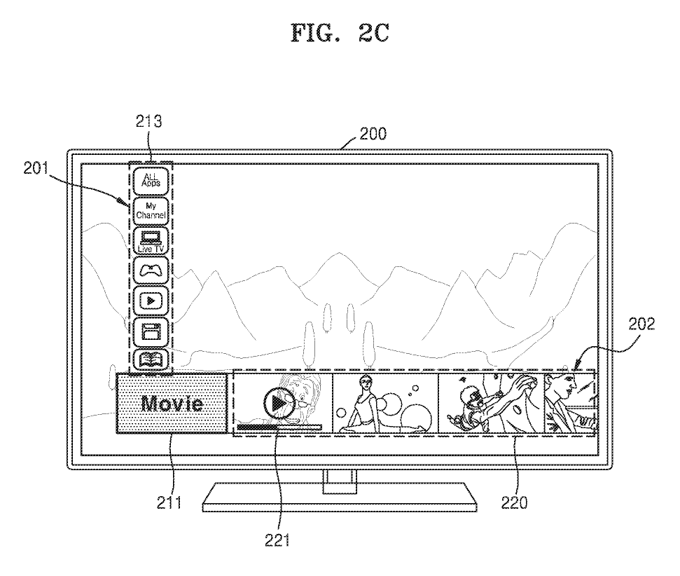

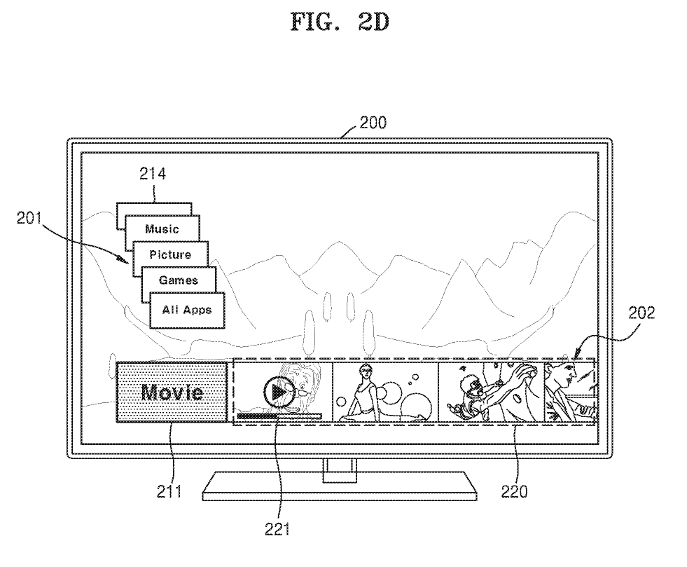

FIG. 2A illustrates an example of displaying a first item area and a second item area which have a 2-level structure, according to another exemplary embodiment.

Referring to FIG. 2A, a display apparatus 200 may receive an input of a control signal from a user by using a direction key 250 displayed on a screen instead of the controller 150 of FIG. 1. For example, when the user is not able to find the controller 150, the user may change a control mode of the display apparatus 200 and set the direction key 250 to be shown on the screen.

In this regard, in response to a control signal for moving a focus to a first item, the display apparatus 200 may display the first item by moving the first item to a predetermined location as an item list included in a first item area 201 slides and may arrange a second item area 202 to be adjacent to the predetermined location to which the first item is moved. For example, the predetermined location may be a first location of the first item area 201, and the second item area 202 may be arranged adjacent to the first location of the first item area 201 and vertical to the first item area 201 (e.g., orthogonal to the first item area).

For example, referring to FIG. 2A, based on a user control signal that is input via the direction key 250, a category list 210 may slide so that a movie item 211 displayed on the first item area 201 may move to a focus location. In this regard, a movie thumbnail list 220 corresponding to the movie item 211 may be displayed on the second item area 202.

When the user moves the focus to a certain movie thumbnail 221 corresponding to the movie item 211, the category list 210 may be modified to display more categories. An example of modifying the item list included in the first item area 201 will be described in detail using FIGS. 2B to 2D.

FIG. 2B illustrates an example of displaying a first item area including downscaled items, according to an exemplary embodiment.

When the focus moves to an item of the second item area 202, the display apparatus 200 may display a downscaled item list of the first item area 201. Referring to FIG. 2B, when the focus moves from the movie item 211 to the certain movie thumbnail 221, the display apparatus 200 may display a play button on the certain movie thumbnail 221 and may display a downscaled category list 212 of the first item area 201. In this case, compared with FIG. 2A, the first item area 201 may display more items without moving the screen.

FIG. 2C illustrates an example of displaying a first item area using icons to represent items, according to an exemplary embodiment.

When the focus moves to an item of the second item area 202, the display apparatus 200 may display items of the first item area 201 as icons.

Referring to FIG. 2C, when the focus moves to the certain movie thumbnail 221 corresponding to the movie item 211, the display apparatus 200 may display a play button on the certain movie thumbnail 221 and may display a category list 213 of the first item area 201 using icons.

FIG. 2D illustrates an example of displaying a first item area including overlapped items, according to an exemplary embodiment.

When the focus moves to an item of the second item area 202, the display apparatus 200 may display items of the first item area 201 to overlap each other.

Referring to FIG. 2D, when the focus moves to the certain movie thumbnail 221 corresponding to the movie item 211, the display apparatus 200 may display a play button on the certain movie thumbnail 221 and may display an overlapped category list 214 of the first item area 201.

The display apparatus 100 may display the first item area 201 and the second item area 202 in various ways.

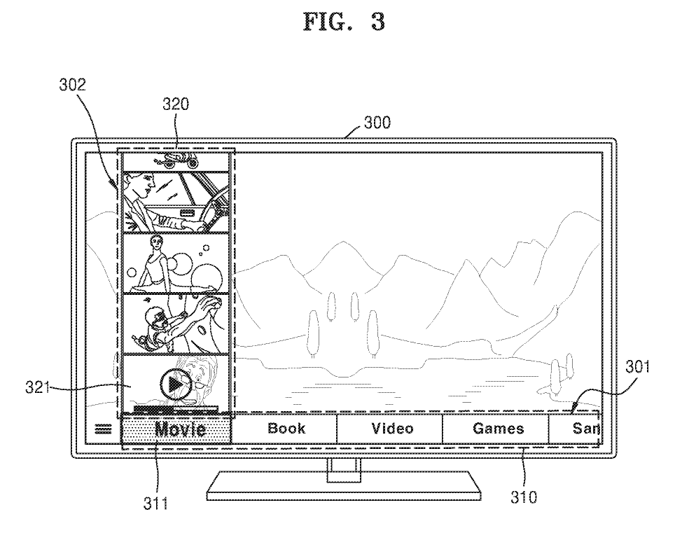

FIG. 3 illustrates an example of displaying a first item area including horizontally arranged items and a second item area including vertically arranged items, according to an exemplary embodiment.

A display apparatus 300 may display a first item area 301 including horizontally arranged items and a second item area 302 including vertically arranged items.

Referring to FIG. 3, a category list 310 may be horizontally arranged at the bottom of a screen, and a movie thumbnail list 320 corresponding to a movie item 311 at which a focus is located may be vertically arranged adjacent to the movie item 311. In this regard, when the focus moves from the movie item 311 to a certain movie thumbnail 321, a play button may be displayed on the certain movie thumbnail 321, and the category list 310 displayed on the first item area 301 may be downscaled.

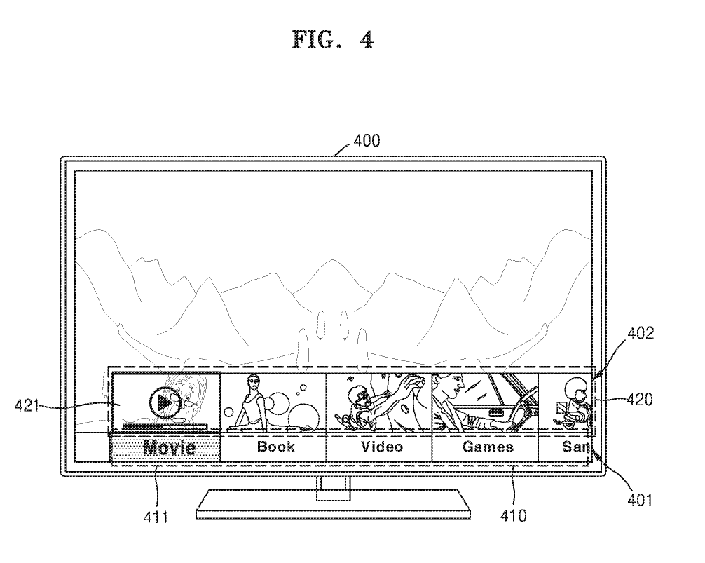

FIG. 4 illustrates an example of displaying a first item area including horizontally arranged items and a second item area horizontally arranged on top of the first item area, according to another exemplary embodiment.

Referring to FIG. 4, a category list 410 may be horizontally arranged at the bottom of a screen, and a movie thumbnail list 420 corresponding to a movie item 411 at which a focus is located may be horizontally arranged while being adjacent to the top of the category list 410. In this regard, when the focus moves from the movie item 411 to a certain movie thumbnail 421, a play button may be displayed on the certain movie thumbnail 421, and the category list 410 displayed on the first item area 401 may be downscaled.

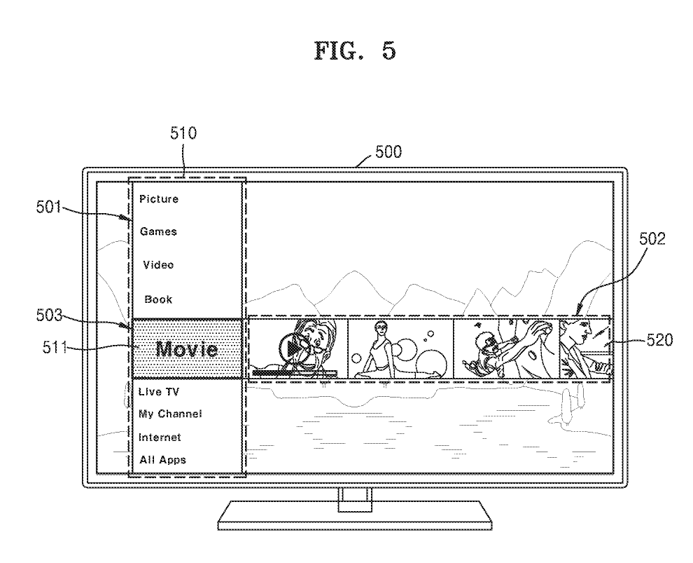

FIG. 5 illustrates an example of displaying a first item area and a second item area which have a 2-level structure, according to another exemplary embodiment.

In response to a control signal for moving a focus to a first item 503, a display apparatus 500 may move the focus to a location of the first item 503 and may arrange a second item area 502 to be adjacent to the location of the first item 503 and vertical to a first item area 501.

Referring to FIG. 5, in response to a control signal for moving a focus to a movie item 511, the display apparatus 500 may move the focus to the movie item 511 and may display a movie thumbnail list 520 corresponding to the movie item 511 to be adjacent and also vertical to the movie item 511. In this regard, when the focus moves to a certain movie thumbnail, the display apparatus 500 may display a play button on the certain movie thumbnail 521 and may downscale a category list 510 displayed on the first item area 501. In this regard, the category list 510 may not slide, and a location of the second item area 502 may differ according to a location of the focus.

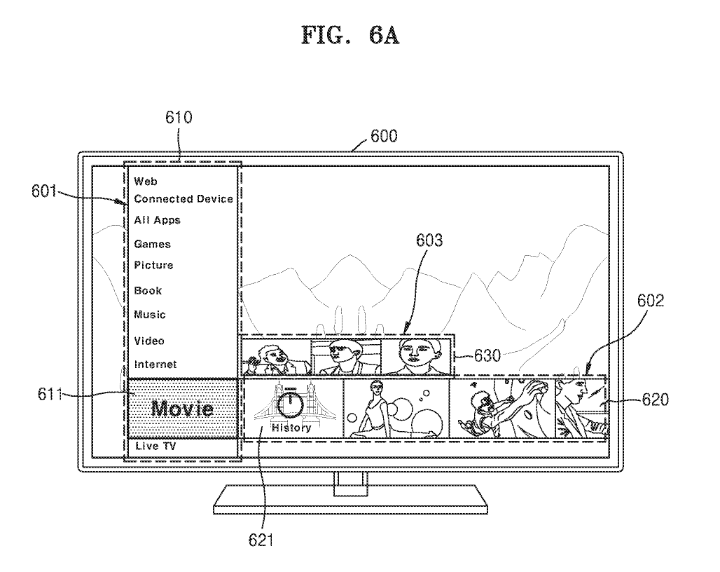

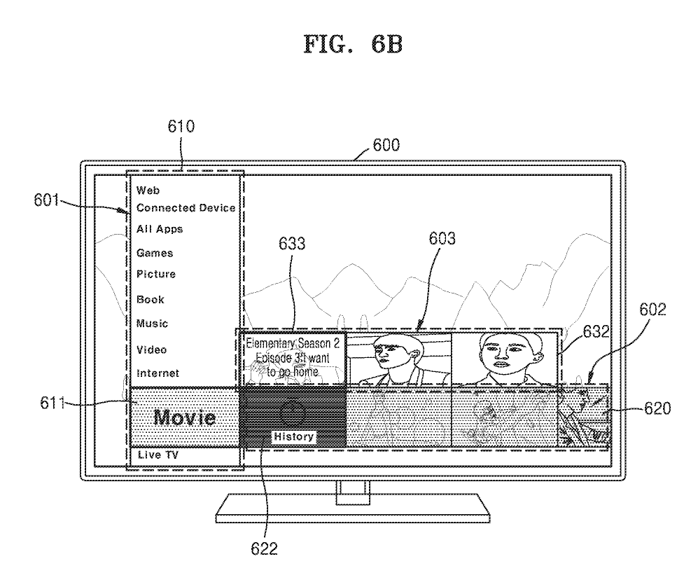

FIGS. 6A and 6B illustrate an example of displaying first to third item areas which have a 3-level structure, according to an exemplary embodiment.

A display apparatus 600 may provide not only a first item area 601 and a second item area 602 but also a third item area 603 on which lower-level items of a second item are displayed.

Referring to FIG. 6A, when a focus moves to a movie item 611 in a category list 610, a movie thumbnail list 620 corresponding to the movie item 611 may be displayed. In this regard, when the focus moves to a certain movie thumbnail 621, the category list 610 displayed on the first item area 601 may be downscaled. In this regard, when a certain movie has a plurality of episodes, the display apparatus 600 may display an icon indicating that the certain movie thumbnail 621 has a plurality of episodes and may display the third item area 603 on top of the movie thumbnail list 620. In this regard, the third item area 603 may display an episode list 630 of the certain movie. A location of the third item area 603 may change.

Also, when the focus moves to the third item area 603, the display apparatus 600 may display an item at which the focus is located to be highlighted.

Referring to FIG. 6B, when the focus moves to an episode thumbnail 633 of the certain movie corresponding to the movie item 611, an episode list 632 displayed on the third item area 603 may be enlarged, and information about a corresponding episode may be displayed on the episode thumbnail 633 at which the focus is located. In this regard, the category list 610 displayed on the first item area 601 may be downscaled, a color of a selected movie thumbnail 622 may be changed, and another movie thumbnail list 620 displayed on the second item area 602 may be displayed blurry.

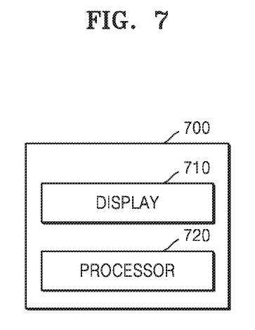

FIG. 7 is a block diagram illustrating a configuration of a display apparatus 700, according to an exemplary embodiment.

The display apparatus 700 may include a display 710 and a processor 720. In the display apparatus 700 illustrated in FIG. 7, only the elements related to exemplary embodiments are illustrated. Accordingly, it will be understood that other general-purpose elements may be further included in addition to the elements illustrated in FIG. 7.

The display apparatus 700 corresponds to the display apparatus 100 of FIG. 1, and thus, detailed descriptions thereof are omitted.

The display 710 may display information and content that are processed by the display apparatus 700. For example, the display 710 may display a plurality of item areas.

When the display 710 and a touchpad have a layered structure and are configured as a touchscreen, the display 710 may be used as an input apparatus as well as an output apparatus. The display 710 may include at least one of a liquid crystal display, a thin film transistor-liquid crystal display, an organic light-emitting diode display, a flexible display, a three-dimensional (3D) display, and an electrophoretic display. In addition, the display apparatus 700 may include two or more displays 710 according to an implementation form of the display apparatus 700. In this regard, the two or more displays 710 may be disposed to face each other by using a hinge.

The processor 720 may control the display 710 to provide a first item area that displays at least a portion of an item list including a plurality of items, provide a second item area that displays, in response to a control signal of a controller for moving a focus to a first item included in the first item area, at least a portion of an item list including lower-level items of the first item, and modify, in response to a control signal for moving the focus to a second item included in the second item area, the item list included in the first item area. In this regard, modifying the item list may include downscaling the item list.

In addition, the processor 720 may control the display 710 to arrange the first item area vertically and arrange the second item area horizontally.

In addition, the processor 720 may control the display 710 to arrange the first item area horizontally and arrange the second item area vertically.

In addition, the processor 720 may control the display 710 to display, in response to the control signal for moving the focus to the first item, the first item by moving the first item to a predetermined location as the item list included in the first item area slides and arrange the second item area to be adjacent to the predetermined location to which the first item is moved. In this regard, the predetermined location may be a first location of the first item area, and the processor 720 may control the display 710 to arrange the second item area to be adjacent to the first location and vertical to the first item area.

In addition, the processor 720 may control the display 710 to move, in response to the control signal for moving the focus to the first item, the focus to a location of the first item and arrange the second item area to be adjacent to the location of the first item and vertical to the first item area.

In addition, the processor 720 may control the display 710 to arrange the first item area horizontally and arrange the second item area horizontally on top of the first item area.

In addition, the processor 720 may control the display 710 to display, in response to the signal for moving the focus to the second item included in the second item area, at least a portion of an item list including lower-level items of the second item.

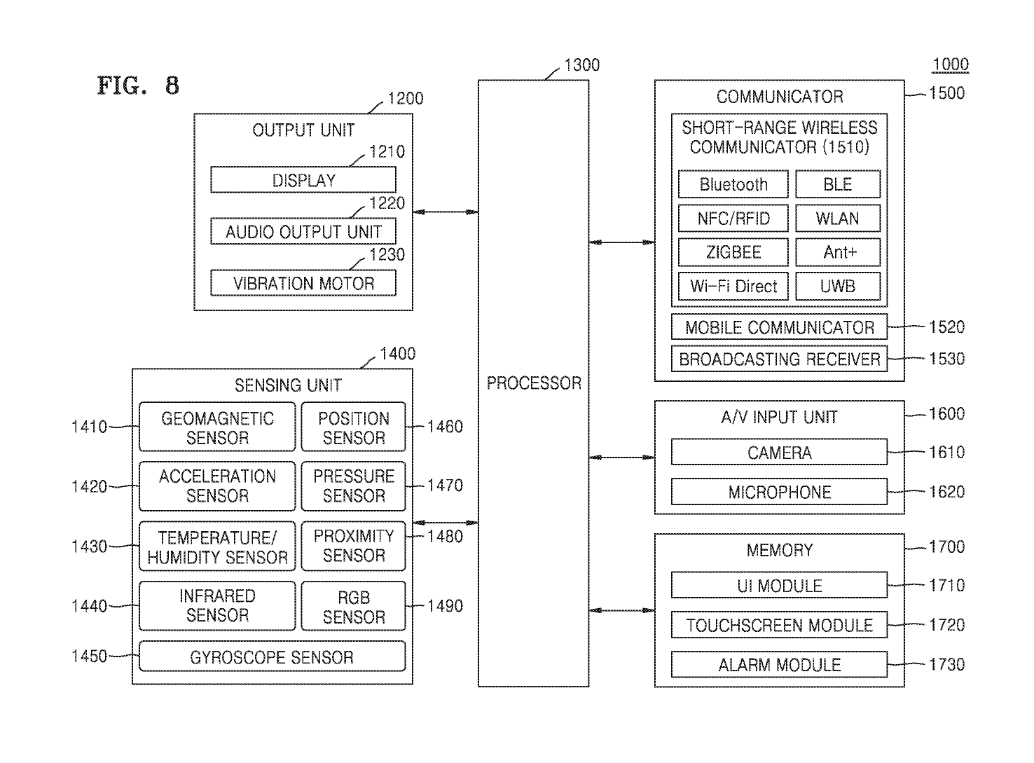

FIG. 8 is a block diagram illustrating a configuration of a display apparatus 1000, according to another exemplary embodiment.

Referring to FIG. 8, the display apparatus 1000 may include a sensing unit 1400, an audio/video (A/V) input unit 1600, and a memory 1700, in addition to an output unit 1200, a processor 1300, and a communicator 1500.

The output unit 1200 may output a sound signal, a video signal, or a vibration signal, and the output unit 1200 may include a display 1210, a sound output unit 1220, and a vibration motor 1230.

The display 1210 corresponds to the display 710 of FIG. 7, and thus, repeated descriptions thereof are omitted.

The sound output unit 1220 outputs audio data received from the communicator 1500 or stored in the memory 1700. The sound output unit 1220 may include a speaker and a buzzer.

The vibration motor 1230 may output a vibration signal. For example, the vibration motor 1230 may output the vibration signal that corresponds to an output of audio data or video data (for example, a call signal reception tone, a message reception tone, etc.).

The processor 1300 corresponds to the processor 720 of FIG. 7, and thus, repeated descriptions thereof are omitted.

The sensing unit 1400 may sense a status of the display apparatus 1000 or a surrounding status of the display apparatus 1000 and may transmit the transmitted information to the processor 1300.

The sensing unit 1400 may include at least one of a geomagnetic sensor 1410, an acceleration sensor 1420, a temperature/humidity sensor 1430, an infrared sensor 1440, a gyroscope sensor 1450, a position sensor (for example, global positioning system (GPS)) 1460, a pressure sensor 1470, a proximity sensor 1480, and an RGB sensor (illuminance sensor) 1490. However, exemplary embodiments are not limited thereto. The function of each sensor may be intuitively inferred from its name, and thus, repeated descriptions thereof are omitted.

The communicator 1500 may include a short-range wireless communicator 1510, a mobile communicator 1520, and a broadcasting receiver 1530.

The short-range wireless communicator 1510 may include a Bluetooth communicator, a Bluetooth low energy (BLE) communicator, a near field communicator, a wireless local area network (WLAN) communicator, a ZigBee communicator, an Infrared Data Association (IrDA) communicator, a Wi-Fi Direct (WFD) communicator, an ultra wideband (UWB) communicator, and an Ant+ communicator. However, exemplary embodiments are not limited thereto.

The mobile communicator 1520 transmits or receives a wireless signal to or from at least one of a base station, an external terminal, and a server over a mobile communication network. In this regard, the wireless signal may include an audio call signal, a video call signal, or various types of data according to text/multimedia message transmission and reception. In one or more exemplary embodiments, the display apparatus 1000 may not include the mobile communicator 1520.

The broadcasting receiver 1530 receives a broadcasting signal and/or information related to broadcasting from the outside through a broadcasting channel. The broadcasting channel may include a satellite channel and a terrestrial channel.

The A/V input unit 1600 is for inputting an audio signal or video signal and may include a camera 1610 and a microphone 1620.

The camera 1610 may obtain an image frame such as a still image or moving picture through an image sensor in a video call mode or scene mode. An image captured through the image sensor may be processed through the processor 1300 or an extra image processor.

The image frame processed in the camera 1610 may be stored in the memory 1700 or may be transmitted to the outside through the communicator 1500. In one or more exemplary embodiments, two or more cameras 1610 may be provided according to the configuration aspect of a terminal.

The microphone 1620 receives an input of an external sound signal and processes the external sound signal into electric audio data. For example, the microphone 1620 may receive a sound signal from an external device or a speaker. The microphone 1620 may use various noise removal algorithms for removing noise that occurs during a process of receiving the input of an external sound signal.

The memory 1700 may store a program for processing and control of the processor 1300 or may store data that is input to the display apparatus 1000 or output by the display apparatus 1000.

The memory 1700 may include at least one type of storage medium from among a flash memory type, a hard disk type, a multimedia card micro type, a card type memory (for example, Secure Digital (SD) or eXtreme Digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk.

Programs stored in the memory 1700 may be classified into a plurality of modules according to the function. For example, the programs may be classified into a user interface (UI) module 1710, a touchscreen module 1720, an alarm module 1730, and the like.

The UI module 1710 may provide a specialized UI, a graphical user interface (GUI), etc. interworking with the display apparatus 1000 for each application. The touchscreen module 1720 may sense a touch gesture on a touchscreen of a user and may transmit information about the touch gesture to the processor 1300. The touchscreen module 1720 according to one or more exemplary embodiments may recognize and analyze a touch code. The touchscreen module 1720 may be configured as a separate hardware including a controller. The alarm module 1730 may generate a signal for indicating event occurrence of the display apparatus 1000. Examples of an event that occurs in the display apparatus 1000 include call signal reception, message reception, key signal input, and schedule notification.

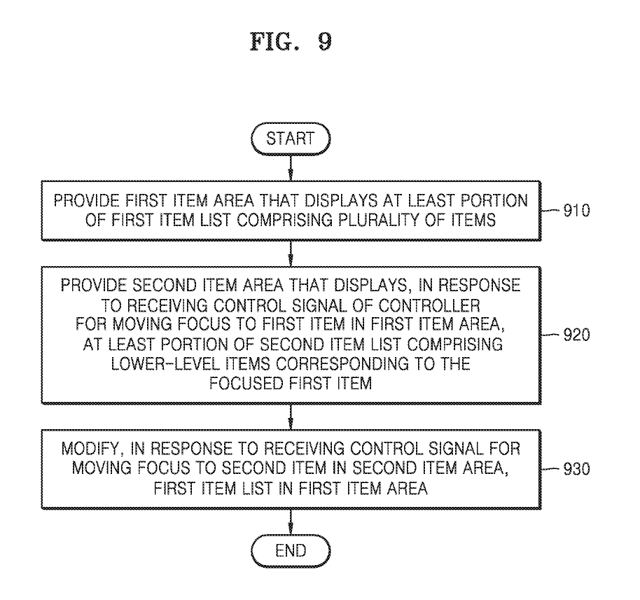

FIG. 9 is a flowchart of a method of displaying a plurality of item areas, according to an exemplary embodiment.

In operation 910, the display apparatus 700 may provide a first item area that displays at least a portion of an item list including a plurality of items.

In operation 920, the display apparatus 700 may provide a second item area that displays, in response to a control signal of a controller for moving a focus to a first item included in the first item area, at least a portion of an item list including lower-level items of the first item.

In this regard, the first item area may be vertically arranged on a screen, and the second item area may be horizontally arranged. Referring to FIG. 1, the first item area 101 may be vertically arranged on a left side of the screen, and the second item area 102 may be horizontally arranged at the bottom of the screen.

In addition, the first item area may be horizontally arranged, and the second item area may be vertically arranged. Referring to FIG. 3, the category list 310 displayed on the first item area 301 may be horizontally arranged at the bottom of the screen, and the movie thumbnail list 320 displayed on the second item area 302 may be vertically arranged on the left side of the screen.

In addition, the first item area may be horizontally arranged, and the second item area may be horizontally arranged on top of the first item area. Referring to FIG. 4, the category list 410 displayed on the first item area 401 may be horizontally arranged at the bottom of the screen, and the movie thumbnail list 420 displayed on the second item area 402 may be horizontally arranged on top of the category list 410.

In response to the control signal for moving the focus to the first item, the first item may be moved to a predetermined location and be displayed as the item list included in the first item area slides, and the second item area may be arranged adjacent to the predetermined location to which the first item is moved. In this regard, the predetermined location may be a first location of the first item area, and the second item area may be arranged adjacent to the first location and vertical to the first item area. Referring to FIG. 1, a location of the focus may be the first location of the first item area 101, and when the focus moves, the item list included in the first item area 101 may be displayed by sliding. Accordingly, in response to the focus moving from the Live TV item 111 to a movie item, the category list 110 may be moved so that the movie item may be located in the first location of the first item area 101, and the movie thumbnail list 120 may be displayed to be adjacent to the location of the focus.

In addition, in response to the control signal for moving the focus to the first item, the focus may be moved to a location of the first item, and the second item area may be arranged adjacent to the location of the first item and vertical to the first item area. Referring to FIG. 5, the category list 510 displayed on the first item area 501 may be fixed, and the focus may be moved. In this regard, the second item area 502 may be displayed to be adjacent to the first item 503 that is at the location of the focus in the first item area 501.

In operation 930, in response to a control signal for moving the focus to a second item included in the second item area, the display apparatus 700 may modify the item list included in the first item area.

In this regard, as a method of modifying the item list included in the first item area, the item list included in the first item area may be downscaled, items may be replaced with simple icons, or the items may be displayed to overlap each other. However, the method of modifying the item list included in the first item area is not limited thereto.

In addition, in response to the control signal for moving the focus to the second item included in the second item area, the display apparatus 700 may provide a third item area that displays at least a portion of an item list including lower-level items of the second item. Referring to FIG. 6A, when the focus is moved to the movie item 611 of the first item area 601, the movie thumbnail list 620 corresponding to the movie item 611 may be displayed on the second item area 602, and at this time, the focus may be moved from the movie thumbnail list 620 to the certain movie thumbnail 621. If the focus moves to the certain movie thumbnail 621 having a plurality of episodes, the episode list 630 of the certain movie may be displayed on the third item area 603.

The item list that is displayed on the first item area may refer to one or more categories, and the item list that is displayed on the second item area may refer to one or more pieces of content that correspond to each category.

According to the above description, a number of items may be displayed on a screen by modifying an item list according to a location of a focus and displaying the item list.

One or more of the above exemplary embodiments may be embodied as a program that may be executed by a computer, and may be implemented by a general-purpose digital computer that runs the program by using a computer-readable recording medium. In addition, a structure of data used in one or more of the above exemplary embodiments may be recorded on a computer-readable recording medium by using various units. In addition, one or more of the above exemplary embodiments may be implemented as a recording medium including a computer-executable command such as a program module that is executed by a computer. For example, methods that are implemented as software modules or algorithms may be stored in a computer-readable recording medium as program instructions or codes that are readable and executable by the computer.

A computer-readable recording medium may be an arbitrary recording medium accessible by a computer, and examples thereof include volatile and non-volatile media and separable and non-separable media. Examples of the computer-readable medium include a magnetic storage medium (e.g., read only memory (ROM), a floppy disk, or a hard disk) and an optically readable medium (e.g., a compact disk-read only memory (CD-ROM), or a digital versatile disk (DVD)), but are not limited thereto. Further, examples of the computer-readable recording medium may include a computer storage medium and a communication medium.

Also, computer-readable recording media may be distributed over network-coupled computer systems, and data stored in the distributed computer-readable recording media, for example, program commands and codes, may be executed by at least one computer.

The particular implementations shown and described are illustrative exemplary embodiments and are not intended to otherwise limit the scope of the present disclosure in any way. For the sake of brevity, the recitation of conventional electronics, control systems, software development and other functional aspects of the systems may be omitted.

The above description of one or more exemplary embodiments is for illustrative purposes, and it will be understood that various changes in form and details may be made therein without departing from the technical spirit and essential features. Hence, it should be understood that the exemplary embodiments described above are illustrative in every aspect and are not limiting. For example, each element described as a single type may be executed in a distributed manner, and elements described as being distributed may also be executed in a combined form.

Modifications may be made therein without departing from the essence of the above recitation.

As the present disclosure allows for various changes and numerous exemplary embodiments, the present disclosure is not limited to particular modes of practice recited herein, and it is to be appreciated that all changes, equivalents, and substitutes that do not depart from the spirit and technical scope of the present disclosure are encompassed in the present disclosure. Therefore, it should be understood that exemplary embodiments described herein should be considered in a descriptive sense only and not for purposes of limitation.

It should be understood that the claims and all modifications or modified forms drawn from the meaning, scope, and equivalent concept of the claims are included in the scope of the present disclosure.

As used herein, the terms, such as “ . . . unit”, “-or”, “-er” or “module”, refer to a unit that processes at least one function or operation and that may be implemented in a hardware manner, a software manner, and/or a combination of the hardware manner and the software manner.

What is claimed is:

1. A display apparatus comprising:
a display;
a memory; and
a processor configured to control the display to:
provide a first item area that displays at least a portion of a first item list comprising a plurality of items;
provide a second item area that, in response to receiving a control signal of a controller for moving a focus to a first item in the first item area, displays at least a portion of a second item list comprising lower-level items corresponding to the focused first item, and
modify, in response to receiving a control signal for moving the focus to a second item in the second item area, the first item list.

2. The display apparatus of claim 1, wherein the modifying the first item list comprises downscaling the first item list.

3. The display apparatus of claim 1, wherein the processor is further configured to control the display to arrange the first item area vertically and arrange the second item area horizontally.

4. The display apparatus of claim 1, wherein the processor is further configured to control the display to arrange the first item area horizontally and arrange the second item area vertically.

5. The display apparatus of claim 1, wherein the processor is further configured to, in response to receiving the control signal for moving the focus to the first item, control the display to display the first item by moving the first item to a predetermined location as the first item list slides, and arrange the second item area to be adjacent to the predetermined location to which the first item is moved.

6. The display apparatus of claim 5, wherein the predetermined location is a first location of the first item area, and
the processor is further configured to control the display to arrange the second item area to be adjacent to the first location and orthogonal to the first item area.

7. The display apparatus of claim 1, wherein the processor is further configured to, in response to receiving the control signal for moving the focus to the first item, control the display to move the focus to a location of the first item, and arrange the second item area to be adjacent to the location of the first item and orthogonal to the first item area.

8. The display apparatus of claim 1, wherein the processor is further configured to control the display to arrange the first item area horizontally and arrange the second item area horizontally above the first item area.

9. The display apparatus of claim 1, wherein the processor is further configured to, in response to receiving a control signal for moving the focus to the second item in the second item area, control the display to display at least a portion of the second item list comprising lower-level items of the second item.

10. A method for displaying a plurality of items, the method comprising:
providing a first item area that displays at least a portion of a first item list comprising a plurality of items;
providing a second item area that, in response to a receiving control signal of a controller, for moving a focus to a first item in the first item area, displays at least a portion of a second item list comprising lower-level items corresponding to the focused first item; and
modifying, in response to receiving a control signal for moving the focus to a second item in the second item area, the first item list in the first item area.

11. The method of claim 10, wherein the modifying of the first item list comprises downscaling the first item list.

12. The method of claim 10, wherein the first item area is arranged vertically, and the second item area is arranged horizontally.

13. The method of claim 10, wherein the first item area is arranged horizontally, and the second item area is arranged vertically.

14. The method of claim 10, wherein in response to receiving the control signal for moving the focus to the first item, displaying the first item by moving the first item to a predetermined location as the first item list slides, and arranging the second item area to be adjacent to the predetermined location to which the first item is moved.

15. The method of claim 14, wherein the predetermined location is a first location of the first item area, and the second item area is arranged adjacent to the first location and orthogonal to the first item area.

16. The method of claim 10, wherein the focus is moved to a location of the first item in response to receiving the control signal for moving the focus to the first item, and the second item area is arranged adjacent to the location of the first item and orthogonal to the first item area.

17. The method of claim 10, wherein the first item area is arranged horizontally, and the second item area is arranged horizontally above the first item area.

18. The method of claim 10, further comprising providing a third item area that, in response to receiving a control signal for moving the focus to the second item in the second item area, displays at least a portion of the second item list comprising lower-level items of the second item.

19. The method of claim 10, wherein the first item list displayed on the first item area indicates at least one category, and
the second item list displayed on the second item area indicates at least one piece of content that corresponds to each category.

20. A non-transitory computer-readable recording medium having recorded thereon a program for causing a computer to perform the method of claim 10.
